(19) United States
(12) Patent Application Publication
(10) Pub. No.: US 2007/0182932 A1
(43) Pub. Date: Aug. 9, 2007

(54) Lcd projecting system having dichroic mirrors for polarization conversion

(75) Inventors: Levinus Pieter Bakker, Eindhoven (NL); Adrianus Johannes Stephanes Maria De Vaan, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,607

(22) PCT Filed: Mar. 3, 2005
(86) PCT No.: PCT/IB05/50793

§ 371 Date: Sep. 6, 2006

(30) Foreign Application Priority Data
Mar. 11, 2004 (EP) 04101002.6

(51) Int. Cl. G03B 21/14

(52) U.S. Cl. 353/20

(57) ABSTRACT

This invention relates to a system (200) for projecting an image on a display comprising: a first dichroic means(212) receiving coloured light beams (204, 206, 208) and adapted to transmit the one (204) and to reflect the others (206, 208), a second dichroic means (220) receiving the other light beams (206, 208) and adapted to reflect a second (206) and to transmit a third (208) light beam. The system (200) further comprises a first, second and third polarizing means (216, 304, 222, 404, 226, 602) being adapted to transmit light polarized in a desired direction, and a reflective rotating means (210, 202) receiving light beams (204, 206, 208) polarized in an undesired direction reflected from at least one of the first, second and third polarizing means (216, 304, 222, 404, 226, 602), and which reflective rotating means (210, 202) is adapted to convert the light polarized in the undesired direction to converted light polarized in the desired direction and reflect the converted light back to the first, second and third polarizing means (216, 304, 222, 404, 226, 602).

### FIELD OF INVENTION

This invention relates to a system for projecting images on a screen. In particular, this invention relates to a transmissive projection system comprising dichroic mirrors used as polarizers for polarization conversion in a liquid crystal display (LCD) projector.

### BACKGROUND OF INVENTION

British patent application no. GB 2 354 658, which is considered the closest prior art, discloses a LCD projection system shown in FIG. 1 and comprising a light source 100 positioned in an optical input path of a light collecting optical unit 102 including a first dichroic mirror 104, a dichroic second 106, and a reflective mirror 108. The light source 100 provides red, green and blue light comprising a perpendicular (s-polarized) and a parallel (p-polarized) component. The first dichroic mirror 104 transmits only the p-polarized red light (Rp) while reflecting the other light, namely s-polarized red (Rs), green (Gs), and blue light (Bs) together with p-polarized green (Gp) and blue light (Bp). The second dichroic mirror 106 reflects the s-polarized green (Gs) and blue light (Bs), while transmitting the other light, namely s-polarized red light (Rs), p-polarized green (Gp) and blue (Bp) light. The first and second dichroic mirrors 104, 106 together with the reflective mirror 108 provides a first optical output comprising p-polarized red light (Rp), s-polarized green (Gs) and blue (Bs) light and a second optical output comprising s-polarized red light (Rs), p-polarized green (Gp) and blue (Bp) light. The first optical output is converted in a half wave plate 110 into phase with the second optical output and provided to a beam splitting arrangement 112 separating the s-polarized red light (Rs), p-polarized green (Gp) and blue (Bp) light to be projected onto liquid crystal light valves 114a, 114b, 114c reflecting modulated p-polarized red light (Rp), s-polarized green (Gs) and blue light (Bs) to a projection lens 116. The beam splitting arrangement 112 is an expensive element of the LCD projection system, hence alternative approaches for conversion of polarization are required reducing the number of beam splitters required in the projection system.

European patent application no. EP 0 825 472 discloses a projection type display apparatus comprising a polarization separation unit spatially separating intermediate light beams into a p-polarized light beam and an s-polarized light beam, and aligns the direction of one of both light beams with the direction of the other of both light beams, where after the polarized light beams are guided into their respective colour channels. Hence polarization conversion of the light beams is performed prior to the light enters the channels.

### SUMMARY OF THE INVENTION

An object of the present invention is to provide a system for projecting images on a screen in which number of beam splitters is reduced.

A further object of the present invention is to provide a system utilizing dichroic mirrors for polarization conversion instead of reflective polarizers, such as wire grids, thereby reducing implementation costs.

A particular advantage of the present invention is the provision of a less expensive system and more efficient separation of the different light components of the light beam.

The above objects and advantages together with numerous other objects, advantages and features, which will become evident from below detailed description, are obtained according to a first aspect of the present invention by a system for projecting an image on a display comprising:

a first dichroic means receiving a first, a second and a third primary coloured light beam and adapted to transmit the first and to reflect the second and third primary coloured light beams,

a second dichroic means receiving said second and third primary coloured light beam and adapted to reflect said second primary coloured light and to transmit said third primary coloured light beam, characterized in further comprising:

a first polarizing means receiving said first primary coloured light beam, a second polarizing means receiving said second primary coloured light beam, and a third polarizing means receiving said third primary coloured light beam, which first, second and third polarizing means being adapted to transmit light polarized in a desired direction, and further comprising a reflective rotating means receiving reflected first, second and third primary coloured light beams polarized in an undesired direction from at least one of said first, second and third polarizing means and adapted to convert said light polarized in said undesired direction to converted light polarized in said desired direction and reflect said converted light back to said first, second and third polarizing means.

The polarizing scheme utilised by the system according to a first aspect of the present invention provides a simple and effective conversion requiring only as few reflective polarizers as possible.

The system according to the first aspect of the present invention may further comprise a first, second and third transmissive light valve means receiving the first, the second and the third primary coloured light beam, respectively, and each of the first, second and third transmissive light valve means being adapted to modulate one of the first, the second and the third primary coloured light beams. In addition, the system may further comprise a recombination prism receiving modulated first, second and third primary coloured light from the first, second and third transmissive light valve means, and being adapted to recombine the modulated first, second and third primary coloured light beams into the image to be projected on the display.

The first, the second and the third primary coloured light beam according to the first aspect of the present invention are coloured blue, green and red, respectively. These primary colours are generally utilised for liquid crystal display techniques.

The reflective rotating means according to the first aspect of the present invention may comprise a quarter wave plate adapted to receive the reflected first, second and third primary coloured light beams polarized in the undesired direction and to rotate polarization of the reflected first, second and third primary coloured light beams by 90°. In addition, the reflective rotating means may comprise a patterned mirror having reflective regions adapted to reflect rotated reflected first, second and third primary coloured light beams received from the quarter wave plate back through the quarter wave plate. Thereby a rotation of polarization of reflected first, second and third primary coloured light beams to a desired direction is established. By passing the quarter wave plate twice a linearly rotation of 90° is achieved thus rotating s-polarized light to p-polarized light, or rotating p-polarized light to s-polarized light.

The patterned mirror may further comprise transparent regions adapted to transmit the first, second and third primary coloured light beams polarized in the desired and the undesired direction from a light source to the quarter wave plate.

The first dichroic means according to the first aspect of the present invention may be operable as a low pass filter having a threshold for p-polarized light at the upper spectral limit of the spectral range of the first primary coloured light beam. Hence the first dichroic means, such as a dichroic mirror, may transmit p-polarized blue light while reflecting s-polarized blue light and other coloured light so that no reflective polarizer is required before the first light valve means. Thus an expensive reflective wire grid polarizer is avoided.

The second polarizing means may be adapted to rotate so as to control amount of the second primary coloured light beam reaches the second light valve means, or may in fact be replaced by a normal polarizer. A normal polarizer should in this context be construed as a polarizer transmitting light with one polarization and absorbing light with the other polarization. This is beneficial when the system is utilised for projecting video images, since lesser green coloured light is required.

The second dichroic means according to the first aspect of the present invention may be operable as a high pass filter having a threshold for p-polarized light at the upper spectral limit of the spectral range of the second primary coloured light beam. The first polarizing means may comprise a first polarizer and the second and third polarizing means comprising a reflective polarizer. Hence the second dichroic means, such as a dichroic mirror, reflects s-polarized blue light together with green light and part of the s-polarized red light to the second polarizing means, which reflects all other than p-polarized light back through the reflective rotating means converting the polarizations of the blue and green light.

The second dichroic means according to the first aspect of the present invention may be operable as a notch filter having a lower threshold for s-polarized light at the lower spectral limit of the spectral range of the second primary coloured light beam and an upper threshold for s-polarized light at the upper spectral limit of the spectral range of the second primary coloured light beam. The first polarizing means may comprise a first polarizer, the second polarizing means may comprise a second polarizer, and the third polarizing means may comprise a reflective polarizer. This system may further comprise a third dichroic means operable as a high pass filter having a threshold equal to lower spectral limit of the spectral range of the second primary coloured light beam (206).

Alternatively, this system may comprise a third dichroic means operable as a low pass filter having a threshold for s-polarized light at the lower spectral limit of the spectral range of the third primary coloured light. The low pass filter may have a threshold for p-polarized light above the spectral limit of the spectral range of the third primary coloured light. Additionally or alternatively, a white mirror for reflecting s-polarized light in the spectral range of the first primary coloured light beam, p-polarized light in the spectral ranges of the second and third primary coloured light beams. Hence all the undesired polarizations are converted in what is know as the red channel defined between the third light valve means and reflective rotating means, and thus two or three reflective polarizers may be eliminated thereby further decreasing costs for implementing the system.

Alternatively, the second dichroic means may be operable as a high pass filter having a threshold for s-polarized light at the upper spectral limit of the spectral range of the second primary coloured light beam. The first polarizing means may comprise a first polarizer, the second polarizing means may comprise a second polarizer, and the third polarizing means may comprise a reflective polarizer. This system may further comprise a third dichroic means operable as a high pass filter having a threshold equal to lower spectral limit of the spectral range of the second primary coloured light beam. As before this polarization conversion requires only one reflective polarizer thus simplifying implementation of this system as well as reducing costs for this system.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawing, wherein:

FIG. 1, shows system according to prior art as disclosed in British patent application no. GB 2 354 658 and described above;

FIG. 2, shows a projection system according to a first embodiment of the present invention;

FIG. 3, shows a projection system according to a second embodiment of the present invention;

FIG. 4, shows a projection system according to a third embodiment of the present invention;

FIG. 5, shows a projection system according to a fourth embodiment of the present invention; and

FIG. 6, shows a projection system according to a fifth embodiment of the present invention.

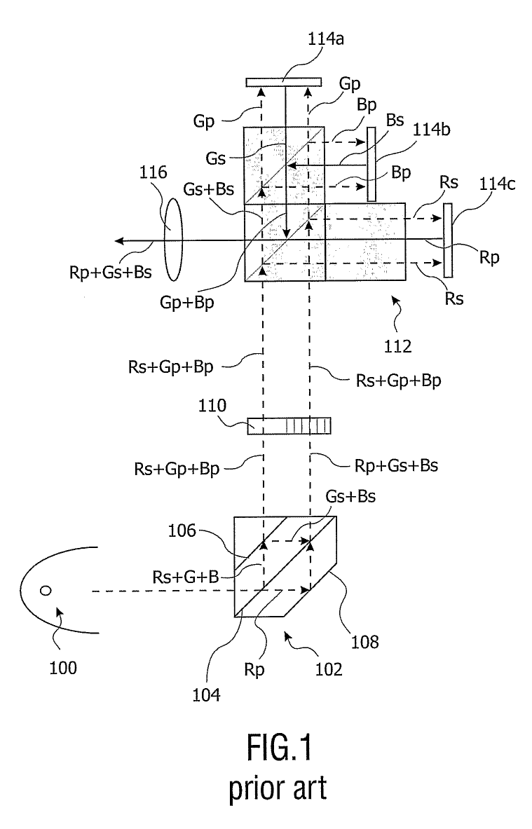

### DETAILED DESCRIPTION OF PREFERRED EMBODIMENTS

In the following description of the various embodiments, reference is made to the accompanying figures, which are shown by way of illustration in which the invention may be practiced. It is to be understood that other embodiments may be utilized and structural and functional modifications may be made without departing from the scope of the present invention.

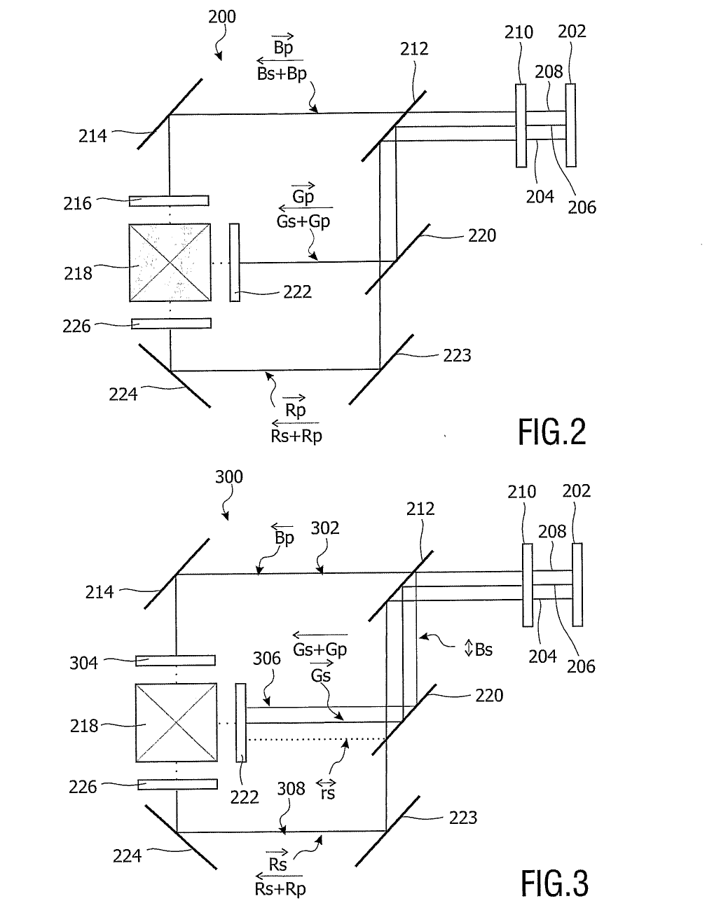

FIG. 2, shows a system 200 according to a first embodiment of the present invention, which system 200 comprises a patterned mirror 202 having transparent regions allowing red 204, green 206 and blue 208 light through a quarter wave plate 210.

The red 204, green 206 and blue 208 light, respectively, defined by a red spectral range, a green spectral range, and a blue spectral range. The red 204, green 206 and blue 208 light is projected on a first dichroic mirror 212 transmitting the blue spectral range. The blue light in the blue spectral range, indicated in FIG. 2 by (Bs+Bp) is, subsequently, reflected by a first reflecting mirror 214 to a first reflective polarizer 216, such as a Moxtek® wire grid, transmitting the s-polarized blue light and reflecting the p-polarized blue light (Bp). The reflected p-polarized blue light (Bp) is thus projected back through the quarter wave plate 210, which introduces a retardation of 90 degrees to the reflected p-polarized blue light (Bp), to reflective regions of the patterned mirror 202. The reflective regions, of the patterned mirror 202 reflects light back through the quarter wave plate 210 again thus introducing 90 degrees retardation for a second time. Thus, the quarter wave plate introduces two times 90 degrees of retardation to the reflected light, i.e. the polarisation is rotated over 90 degrees with respect to the incoming light.

The transmitted s-polarized blue light (Bs) is projected on the recombination prism 218 gathering each of the encoded light beams from each of the coloured light paths, i.e. the red 204, green 206 and blue 208 light paths. The recombined light forms a complete image to be projected through a projection lens onto a projection screen.

FIGS. 2 through 6 do not show lenses, filters and light valves, however, as will be apparent to a person skilled in the art they are required for providing a projection system.

The first dichroic mirror 212 reflects the light in the green and red spectral range to a second dichroic mirror 220, which reflects the green light in the green spectral range. The green light in the green spectral range, indicated in FIG. 2 as (Gs+Gp), is projected to a second reflective polarizer 222 transmitting s-polarized green light (Gs) to the recombination prism 218 and reflecting the p-polarized green light (Gp) back through the quarter wave plate 210 to the reflective regions of the patterned mirror 202.

The second dichroic mirror 220 transmits the red light in the red spectral range, indicated in FIG. 2 as (Rs+Rp), which is projected to a second and third reflecting mirror 223 and 224, respectively, which mirrors 223, 224 reflect the red light (Rs+Rp) to a third reflective polarizer 226 transmitting the s-polarized red light (Rs) to the recombination prism 218 and reflecting the p-polarized red light (Rp) back through the quarter wave plate 210 to reflective regions of the patterned mirror 202.

In general, the spectral behaviour of dichroic mirrors is dependent on wavelength of the light projected on to the dichroic mirrors, however, the spectral behaviour of dichroic mirrors are, in addition, dependent on polarization of light at a specific wavelength. For a dichroic mirror operating as a low pass filter, that is, a filter reflecting light having wavelengths above a certain threshold value and transmitting light having wavelengths below said certain threshold value, and for a high pass filter, that is, a filter oppositely reflecting light having wavelengths below a certain threshold value and transmitting light having wavelengths above said certain threshold value, p-polarized or parallel polarized light having a specific wavelength might be totally transmitted while s-polarized or perpendicular polarized light having said specific wavelength is partly reflected and partly transmitted.

The reflected spectral bandwidth of a notch filter is thus wider for s-polarized light than for p-polarized light and, correspondingly, the transmitted spectral bandwidth of a band pass filter is narrower for s-polarized light than for p-polarized light.

The first and second dichroic mirrors 212 and 220 thus respond differently to s-polarized and p-polarized light. A short wavelength part of the p-polarized green light is transmitted by the first dichroic mirror 212 having a low pass threshold value for s-polarized light at the lower spectral limit for green, since the low pass threshold value for p-polarized light is higher than the low pass threshold value for s-polarized light, and a long wavelength part of the green light is transmitted by the second dichroic mirror 220 having a high pass threshold value for s-polarized light at the upper spectral limit for green, since the high pass threshold value for p-polarized light is lower than the high pass threshold value for s-polarized light.

A middle part of the green spectral range, which is, approximately, half of the bandwidth of the green spectral range, is projected on the second reflective polarizer 222. Since lesser green light is required for video projection, the second reflective polarizer 222 may, in fact, be tilted so as to control the amount of green light reaching the recombination prism 218. By the tilting of the second reflective polarizer 222 a particular advantage is achieved, since this provides excellent means for changing the performance optimization from business to video. For video projection the second reflective polarizer 222 may be substituted by a normal polariser.

FIG. 3 shows a system 300 according to a second embodiment of the present invention, which system 300 comprises some of the elements as described with reference to FIG. 2 and said elements are numbered as in FIG. 2.

In this system 300, the first dichroic mirror 212 according to the second embodiment of the present invention operates as a low pass filter having a threshold for p-polarized light at the upper spectral limit and for s-polarized light at the lower spectral limit of the blue spectral range. The first dichroic mirror 212 thus transmits a major part of the p-polarized blue light in the blue spectral range, indicated by (Bp) in FIG. 3, and reflects s-polarized blue light (Bs) together with the green light (Gs+Gp) and the red light (Rs+Rp).

Hence no polarization conversion is required in a blue channel 302 defined between a first polarizer 304, substituting the first reflective polarizer according to the first embodiment of the present invention, and the patterned mirror 202. The first polarizer 304 transmits p-polarized blue light (Bp) to the recombination prism 218.

The second dichroic mirror 220 according to the second embodiment of the present invention operates as a high pass filter having a threshold for p-polarized light at the upper spectral limit of the green spectral range. The second dichroic mirror 220 thus transmits the red light (Rs+Rp) and reflects the green light (Gs+Gp) together with s-polarized blue light (Bs). By selecting the threshold for p-polarized light at the upper spectral limit of the green spectral range, a part of the s-polarized red light (rs) is reflected by the second dichroic mirror 220.

Thus, polarization conversion is required in a green channel 306 defined between the second reflective polarizer 222 and the patterned mirror 202. The second reflective polarizer 222 transmits p-polarized green light (Gp) to the recombination prism 218 and reflects the s-polarized green light (Gs) together with the part of s-polarized red light (rs) and the s-polarized blue light (Bs) back through the quarter wave plate 210 to reflective regions of the patterned mirror 202, thereby converting the polarization of the light in the green channel 306.

Further, polarization conversion is required in a red channel 308 defined between the third reflective polarizer 226 and the patterned mirror 202. The third reflective polarizer 226 transmits the p-polarized red light (Rp) to the recombination prism 218 and reflects the s-polarized red light (Rs) back through the quarter wave plate 210 to reflective regions of the patterned mirror 202, thereby converting the polarization of the light in the red channel 308.

The system 300 according to the second embodiment of the present invention thus eliminates the requirement for the first reflective polarizer 216. This achievement provides a significant cost reduction in implementation of the system 300.

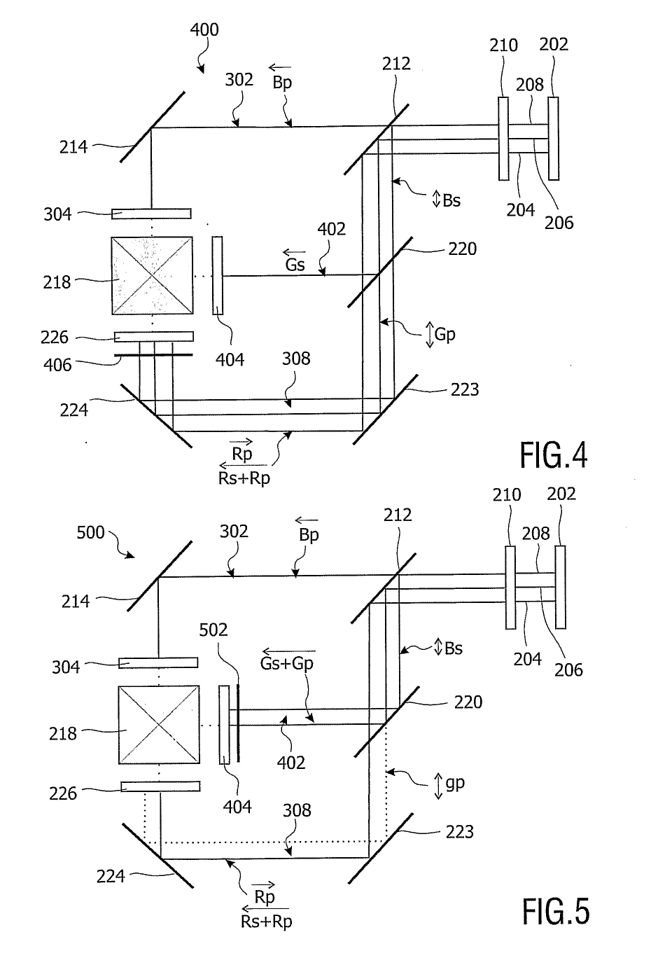

FIG. 4 shows a system 400 according to a third embodiment of the present invention, which system 400 comprises some of the elements as described with reference to FIGS. 2 and 3, and said elements are numbered as in FIGS. 2 and 3.

The first dichroic mirror 212 according to the third embodiment of the present invention operates as a low pass filter having a threshold for p-polarized light at the upper spectral limit and for s-polarized light at the lower spectral limit of the blue spectral range. The first dichroic mirror 212 thus transmits a major part of the p-polarized blue light in the blue spectral range, indicated by (Bp) in FIG. 4, and reflects s-polarized blue (Bs) light together with the green light (Gs+Gp) and red light (Rs+Rp). As described with reference to FIG. 3, hence no polarization conversion is required in the blue channel 302 and, consequently, only the first polarizer 304 transmitting p-polarized blue light (Bp) to the recombination prism 218 is required.

The second dichroic mirror 220 according to the third embodiment of the present invention operates as a notch filter having a lower threshold for s-polarized light at the lower spectral limit of the green spectral range and an upper threshold for s-polarized green light at the upper spectral limit of the green spectral range. It is, particularly, advantageous to select the lower and upper threshold wavelength values for p-polarized light so that the p-polarized bandwidth is as narrow as possible, preferably zero bandwidth, so as to avoid any p-polarized green light (Gp) in a green channel 402 defined between a second polarizer 404, substituting the second reflective polarizer according to the first and second embodiment of the present invention, and the patterned mirror 202. Hence the requirement for the second reflective polarizer 222 is now eliminated from the green channel 402, thereby further reducing the costs for implementing the system 400.

The second dichroic mirror 220 thus reflects the full bandwidth of s-polarized green light (Gs) in the green spectral range, that is, the upper and lower thresholds are chosen so as to transmit p-polarized green light (Gp) in the red channel 308 together with together with the s-polarized blue light (Bs) and the red light(Rs+Rp). The s-polarized blue light (Bs) is reflected back through the quarter wave plate 210 to the reflective regions of the patterned mirror 202 by a dichroic high pass filter 406 having a threshold equal to the lower spectral limit of the green spectral range.

In addition, the dichroic high pass filter 406 may be substituted by a half wave retarder, which rotates polarization only for the blue and green light.

The first polarizer 304 in the system 400 transmits p-polarized blue light (Bp) in the blue spectral range to the recombination prism 218. The second polarizer 404 transmits s-polarized green light (Gs) in the green spectral range to the recombination prism 218. The third reflective polarizer 226 transmits the s-polarized red light (Rs) in the red spectral range to the recombination prism 218 and reflects the p-polarized red light (Rp) together with the p-polarized green light (Gp) in the red channel 308 back through the quarter wave plate 210 to reflective regions of the patterned mirror 202, thereby entirely performing conversion of polarization of the light in the red channel 308.

Hence, the system 400 according to the third embodiment of the present invention thus further simplifies the conversion by eliminating the requirement for the first and second reflective polarizer 216, 222. This achievement provides a significant cost reduction in implementation of the system 400.

FIG. 5 shows a system 500 according to a fourth embodiment of the present invention, which system 500 comprises some of the elements as described with reference to FIGS. 2, 3 and 4 and said elements are numbered as in FIGS. 2, 3 and 4.

The first dichroic mirror 212 according to the fourth embodiment of the present invention operates as a low pass filter having a lower threshold for p-polarized light at the upper spectral limit and for s-polarized light at the lower spectral limit of the blue spectral range. The first dichroic mirror 212 thus transmits a major part of p-polarized blue light in the blue spectral range, indicated by (Bp) in FIG. 5, and reflects s-polarized blue (Bs) light together with the green light (Gs+Gp) and red light (Rs+Rp). As described with reference to FIGS. 3 and 4, hence no polarization conversion is required in the blue channel 302 and, consequently, only the first polarizer 304 transmitting p-polarized blue light (Bp) to the recombination prism 218 is required.

The second dichroic mirror 220 according to the fourth embodiment of the present invention operates as a high pass filter having a threshold for s-polarized light at the upper spectral limit of the green spectral range. The second mirror 220 thus transmits a part of p-polarized green light (gp) into the red channel 308 together with red light (Rs+Rp) and reflects s-polarized blue light (Bs) together with green light (Gs+Gp).

The s-polarized blue light (Bs) in the green channel 402 is reflected back through the quarter wave plate 210 to the reflective regions of the patterned mirror 202 by a dichroic high pass filter 502 having a threshold wavelength value at the lower spectral limit of the green spectral range.

The first polarizer 304 transmits the p-polarized blue light (Bp) in the blue spectral range to the recombination prism 218. The second polarizer 404 transmits part of the s-polarized green light (Gs) to the recombination prism 218, while the dichroic high pass filter 502 reflects the s-polarized blue light (Bs) back through the quarter wave plate 210 to reflective regions of the patterned mirror 202, thereby performing a polarization conversion of blue light in the green channel 402. The third reflective polarizer 226 transmits the s-polarized red light (Rs) and reflects p-polarized red light (Rp) together with the part of p-polarized green light (gp) back through the quarter wave plate 210 to reflective regions of the patterned mirror 202, thereby performing polarization conversion of part of the green light, and all the red light in the red channel 308.

It should be noted, that insertion of the dichroic high pass filter 502 before the second polarizer 404 in the green channel 402 provides a simple and elegant solution for reducing costs of the system 500, since no reflective polarizer is required in the green channel 402. Note that some p-polarized green light is lost in the second polarizer 404.

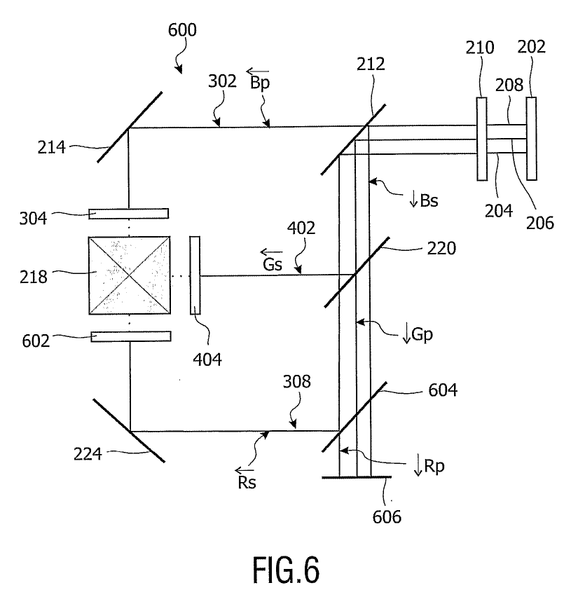

FIG. 6 shows a system 600 according to a fifth embodiment of the present invention, which system 600 comprises some of the elements as described with reference to FIGS. 2, 3, 4 and 5 and said elements are numbered as in FIGS. 2, 3, 4 and 5.

System 600 comprises the first and second dichroic mirrors 212, 220 operating as described with reference to system 400 shown in FIG. 4. That is, the p-polarized blue light (Bp) in the blue spectral range is transmitted to the first polarizer 304 by the first dichroic mirror 212, the s-polarized green light (Gs) is reflected to the second polarizer 404 by the second dichroic mirror 212, and s-polarized red light (Rs) is reflected to a third polarizer 602 by a third dichroic mirror 604.

The third dichroic mirror 604 operates as a low pass filter having a threshold for s-polarized light at the lower spectral limit of the red spectral range. The threshold for p-polarized light is higher, preferably above the upper spectral limit of the red spectral range.

The third dichroic mirror 604 thus transmits the s-polarized blue light (Bs), p-polarized green light (Gp) and p-polarized red light (Rp) to a white mirror 606. Hence no reflective polarizers are required in either the blue, green or red channel 302, 402, 308. The white mirror 606 is at a position of the window image, that is, it is to be illuminated in the same way as the light valves (i.e. LCDs) and polarizers.

1. A system (200, 300, 400, 500, 600) for projecting an image on a display comprising:
a first dichroic means(212) receiving a first (204), a second (206) and a third (208) primary coloured light beam and adapted to transmit the first (204) and to reflect the second (206) and third (208) primary coloured light beams,
a second dichroic means (220) receiving said second (206) and third (208) primary coloured light beam and adapted to reflect said second (206) primary coloured light and to transmit said third (208) primary coloured light beam, characterized in further comprising:
a first polarizing means (216, 304) receiving said first primary coloured light beam (204), a second polarizing means (222, 404) receiving said second primary coloured light beam (206), and a third polarizing means (226, 602) receiving said third primary coloured light beam (208), which first, second and third polarizing means (216, 304, 222, 404, 226, 602) being adapted to transmit light polarized in a desired direction, and further comprising a reflective rotating means (210, 202) receiving reflected first, second and third primary coloured light beams (204, 206, 208) polarized in an undesired direction from at least one of said first, second and third polarizing means (216, 304, 222, 404, 226, 602) and adapted to convert said light polarized in said undesired direction to converted light polarized in said desired direction and reflect said converted light back to said first, second and third polarizing means (216, 304, 222, 404, 226, 602).

2. A system (200, 300, 400, 500, 600) according to claim 1 further comprising a first, second and third transmissive light valve means receiving said first, said second and said third primary coloured light beam (204, 206, 208), respectively, and each of said first, second and third transmissive light valve means being adapted to modulate one of said first, said second and said third primary coloured light beams (204, 206, 208).

3. A system (200, 300, 400, 500, 600) according to claim 2, further comprising a recombination prism (218) receiving modulated first, second and third primary coloured light from said first, second and third transmissive light valve means, and being adapted to recombine said modulated first, second and third primary coloured light beams into said image to be projected on said display.

4. A system (200, 300, 400, 500, 600) according to claim 1, wherein said first, said second and said third primary coloured light beam (204, 206, 208) are coloured blue, green and red, respectively.

5. A system (200, 300, 400, 500, 600) according to claim 1, wherein said reflective rotating means (202, 210) comprises a quarter wave plate (210) adapted to receive said reflected first, second and third primary coloured light beams (204, 206, 208) polarized in said undesired direction and to rotate polarization of said reflected first, second and third primary coloured light beams (204, 206, 208) by 900, and a patterned mirror (202) having reflective regions adapted to reflect rotated reflected first, second and third primary coloured light beams (204, 206, 208) received from said quarter wave plate (210) back through said quarter wave plate (210) thereby establishing a rotation of polarization of reflected first, second and third primary coloured light beams (204, 206, 208) to a desired direction.

6. A system (200, 300, 400, 500, 600) according to claim 5, wherein said patterned mirror (20) comprises transparent regions adapted to transmit said first, second and third primary coloured light beams (204, 206, 208) polarized in said desired and said undesired direction from a light source to said quarter wave plate (210).

7. A system (300, 400, 500, 600) according to claim 1, wherein said first dichroic means (212) is operable as a low pass filter having a threshold for p-polarized light at the upper spectral limit of the spectral range of said first primary coloured light beam (204).

8. A system (300) according to claim 1, wherein said second dichroic means (220) is operable as a high pass filter having a threshold for p-polarized light at the upper spectral limit of the spectral range of the second primary coloured light beam (206).

9. A system (300, 400, 500, 600) according to claim 7, wherein said first polarizing means comprising a first polarizer (304) and said second and third polarizing means comprising a reflective polarizer (226, 222).

10. A system (400, 600) according to claim 1, wherein said second dichroic means (220) is operable as a notch filter having a lower threshold for s-polarized light of the lower spectral limit of the spectral range of said second primary coloured light beam (206) and an upper threshold for s-polarized light at the upper spectral limit of the spectral range of said second primary coloured light beam (206).

11. A system (400,600) according to claim 10, wherein said first polarizing means comprising a first polarizer (304), said second polarizing means comprising a second polarizer (404), and said third polarizing means comprising a reflective polarizer (226).

12. A system (400) according to claim 11 further comprising a third dichroic means (406) operable as a high pass filter having a threshold equal to lower spectral limit of the spectral range of said second primary coloured light beam (206).

13. A system (600) according to claim 11 further comprising a third dichroic means (604) operable as a low pass filter
having a threshold for s-polarized light at the lower spectral limit of the spectral range of said third primary coloured light (208).

14. A system (600) according to claim 13, wherein said low pass filter having a threshold for p-polarized light above the spectral limit of the spectral range of said third primary coloured light (208).

15. A system (600) according to claim 13 further comprising a white mirror (606) for reflecting s-polarized light in the spectral range of said first primary coloured light beam (204), p-polarized light in the spectral ranges of said second and third primary coloured light beams (206, 208).

16. A system (500) according to claim 1, wherein said second dichroic means (220) is operable as a high pass filter having a threshold for s-polarized light at the upper spectral limit of the spectral range of said second primary coloured light beam (206).

17. A system (500) according to claim 16, wherein said first polarizing means comprising a first polarizer (304), said second polarizing means comprising a second polarizer (404), and said third polarizing means comprising a reflective polarizer (226).

18. A system (500) according to claim 17 further comprising a third dichroic means (502) operable as a high pass filter having a threshold for s-polarized light at the upper spectral limit of the spectral range of the second primary coloured light beam (206).

19. A system (200) according to claim 2, wherein said second polarizing means (222) is adapted to rotate so as to control amount of said second primary coloured light beam (206) reaches said second light valve means.

20. A system (200) according to claim 2, wherein said second polarizing means (222) comprises a normal polarizer.
